(19) United States
(12) Patent Application Publication
(10) Pub. No.: US 2022/0111550 A1
(43) Pub. Date: Apr. 14, 2022

(54) CHAIN SAW AND METHOD FOR OPERATING A CHAIN SAW

(71) Applicant: Andreas Stihl AG & Co. KG, Waiblingen (DE)

(72) Inventors: Johannes Menzel, Wernau (DE); Marc Schmid, Oppenweiler (DE)

(21) Appl. No.: 17/496,520

(22) Filed: Oct. 7, 2021

(30) Foreign Application Priority Data
Oct. 12, 2020 (EP) 20 201 369.4

(51) Int. Cl. B27B 17/14; B27B 17/02; B27B 17/00

(52) U.S. Cl. CPC B27B 17/14; B27B 17/0008; B27B 17/02

(57) ABSTRACT

The disclosure relates to a chain saw having a housing and a drive motor. The drive motor by way of a chain drive sprocket drives a saw chain guided on a guide bar. The guide bar is held on the housing by way of a releasable fastening arrangement and by way of a tensioning device is displaceable in the direction of the longitudinal axis of the guide bar in relation to the housing while the fastening arrangement is released. The saw chain has a slack side between the chain drive sprocket and the guide bar. The chain saw includes a chain lifting device which is configured separately from the tensioning device. The chain lifting device is configured for deflecting the saw chain in the direction away from the longitudinal axis of the guide bar.

### CROSS REFERENCE TO RELATED APPLICATION

This application claims priority of European patent application no. 20 201 369.4, filed Oct. 12, 2020, the entire content of which is incorporated herein by reference.

### TECHNICAL FIELD

The disclosure relates to a chain saw and to a method for operating a chain saw.

### BACKGROUND

Chain saws are known which include a housing, a drive motor and a guide bar, the drive motor by way of a chain drive sprocket driving a saw chain guided on a guide bar. The guide bar is releasably held on the housing of the chain saw by means of a fastening arrangement. For readjusting the tension of the saw chain, the guide bar is tensioned by way of a tensioning device while the fastening arrangement is released.

An increase in the noise level could be observed in the operation of chain saws of this type. Increased noise emissions are very intrusive for the operator of the chain saw or else for the direct environment. Furthermore, in the operation of such chain saws it could be observed that the saw chain jumps from the chain drive sprocket or from the guide bar, respectively. The chain saw is no longer capable of functioning or is potentially even defective once the chain saw jumps off. Refitting the saw chain, or repairing the latter, leads to undesirable interruptions in terms of work and to increased costs.

### SUMMARY

It is an object of the invention to provide a chain saw of the generic type which enables a reliable operation of the chain saw at a reduced noise level.

This object can, for example, be achieved via a chain saw having: a housing; a chain drive sprocket; a guide bar defining a longitudinal axis; a saw chain guided on the guide bar; a drive motor configured to drive the saw chain guided on the guide bar via the chain drive sprocket; a releasable fastening arrangement; a tensioning device; the guide bar being held on the housing via the releasable fastening arrangement; the guide bar being displaceable via the tensioning device in a direction of the longitudinal axis of the guide bar in relation to the housing when the fastening arrangement is released; the saw chain having a slack side between the chain drive sprocket and the guide bar; a chain lifting device configured separately from the tensioning device; the chain lifting device being configured to deflect the saw chain in a direction away from the longitudinal axis of the guide bar; and, the chain lifting device including a magnet, wherein the saw chain is deflectable via a magnetic force exerted by the magnet at the slack side.

It is a further object of the invention to specify a method for operating a chain saw which enables a reliable operation of the chain saw at a reduced noise level.

This further object can, for example, be achieved via a method for operating a chain saw, the chain saw including a housing, a chain drive sprocket, a guide bar defining a longitudinal axis, a saw chain guided about the guide bar, and a drive motor configured to drive the saw chain via the chain drive sprocket, the chain saw further including a chain lifting device having a magnet, the saw chain having a slack side. The method includes: deflecting the saw chain on the slack side in a direction away from the longitudinal axis of the guide bar via a magnetic force exerted by the magnet.

The chain saw according to the disclosure is based on the concept that the increase in the noise level in the operation of the chain saw can be traced back to the interaction between the saw chain and the guide bar. The wear on the chain drive sprocket, on the guide bar and on the saw chain, and the heating of the saw chain, lead to a reduction in terms of the saw chain tension. This in turn causes sagging of the saw chain on the slack side of the saw chain, the slack side being configured in the direction of movement of the saw chain between the chain drive sprocket and the guide bar. The slack side is the loose, sagging side of the saw chain that is not under tension. When the sagging of the saw chain on the slack side increases, the angle at which the saw chain contacts the guide bar also changes. The smaller the contact angle between the saw chain and the guide bar, the less noisy the chain saw during operation. As the sagging of the saw chain on the slack side increases, the contact angle between the saw chain and the guide bar is increased, as a result of which the noise level of the chain saw increases.

The guide bar of the chain saw according to the disclosure is held on the housing by way of a releasable fastening arrangement and when a tensioning device is actuated is displaceable in the direction of the longitudinal axis of the guide bar in relation to the housing while the fastening arrangement is released. The chain saw includes a chain lifting device which is configured separately from the tensioning device. The chain lifting device is configured for deflecting the saw chain in the direction away from the longitudinal axis of the guide bar.

The chain lifting device deflects the saw chain on the slack side in the direction away from the longitudinal axis of the guide bar, as a result of which sagging of the saw chain on the slack side is reduced, in particular avoided, also during the operation of the chain saw. The contact angle between the saw chain and the guide bar at the end of the slack side is reduced by the chain lifting device. The noise level of the chain saw is also reduced as a result. Even when the saw chain is elongated in the operation of the chain saw, the chain lifting device acts on the saw chain in such a manner that the contact zone in which the chain contacts the guide bar after passing through the slack side in the direction of the longitudinal axis is displaced away from the chain drive sprocket, wherein the contact angle between the saw chain and the guide bar remains substantially constant. As a result, the noise level during the operation of the chain saw can also be kept substantially constant.

A further advantage of the chain lifting device lies in that the contact forces between the saw chain and the guide bar are also reduced as a result of the reduction of the contact angle. Material fatigue in the saw chain and the guide bar can be avoided as a result, this increasing the service life of the chain saw.

A further advantage lies in that the saw chain remains tensioned also during the operation of the chain saw. A reduction in terms of the noise is thus guaranteed during the entire operation of the chain saw.

The chain lifting device is preferably configured for deflecting the saw chain in the slack side. Accordingly, the chain lifting device acts on the saw chain directly on the slack side of the latter. Already slight forces thus suffice in order for the saw chain to be deflected away from the longitudinal axis of the guide bar, the forces causing a reduction of the sagging and thus also of the contact angle.

The chain lifting device is in particular configured for deflecting the saw chain during the operation of the chain saw.

An increase in the sagging of the saw chain in the slack side, and thus also an increase in the noise level during the operation of the chain saw, is avoided as a result.

The chain lifting device can advantageously be disposed on the housing so as to be adjacent to the slack side. As a result, the chain lifting device can act on the saw chain in a targeted manner on the slack side. Alternatively, the chain lifting device could be disposed on the taut side so as to be adjacent to the taut side. In such an embodiment, the chain lifting device would have to be conceived in such a manner that significantly higher forces act on the saw chain in order for the sagging on the slack side to be reduced.

It is considered is advantageous that the chain lifting device has an operating position and an off position, the chain lifting device causing the deflection of the saw chain only in the operating position. The chain lifting device in the off position does not act on the saw chain. In the off position of the chain lifting device, the saw chain can be tensioned by means of the tensioning device by displacing the guide bar. The chain lifting device in the off position thereof does not counteract the tensioning device. This enables easy readjusting of the tension of the saw chain. When the chain saw is subsequently put into operation, the chain lifting device is again situated in the operating position as a result of which the chain lifting device additionally acts on the saw chain.

The chain lifting device preferably includes a magnet, the saw chain on the slack side being able to be deflected in particular by a magnetic force which is exerted by the magnet. Direct contact between the chain lifting device and the saw chain can be avoided as a result of the saw chain being deflected by means of a magnet. As a result, the chain lifting device can act on the saw chain without wear on the latter and without any emission of noise.

The chain saw, for the avoidance of contact between the chain lifting device and the saw chain, can preferably have a protective contact which is connected to a motor control unit. By way of the chain lifting device, the saw chain remains tensioned also during the operation of the chain saw such that the operator cannot spot the elongation of the saw chain during the operation of the chain saw. After a corresponding operating life of the chain saw, the elongation could lead to contact between the chain lifting device and the saw chain, as a result of which damage to the respective parts could occur. A protective contact is provided in order for this to be avoided. The protective contact interacts in particular with a protective plate. The protective plate is disposed between the saw chain and the chain lifting device such that mutual contact between the saw chain and the chain lifting device is avoided. The protective plate can preferably be configured so as to be resilient. If the saw chain contacts the protective plate, the latter springs back and simultaneously activates the protective contact. The signal emitted by the protective contact is detected by the motor control unit. Corresponding measures which allow the operator to realize that the tension of the saw chain has to be readjusted are then initiated by way of the motor control unit.

In an embodiment, the chain lifting device includes a position sensor for detecting the spacing between the magnet and the saw chain. As a result, the operator can be informed in a timely manner about the magnitude of the deflection of the saw chain and optionally about when the tension of the saw chain has to be readjusted. This can preferably take place by way of a warning indicator which signals the spacing between the magnet and the saw chain that has been determined by the position sensor. As a result, the operator by way of the tensioning device can readjust the tension of the saw chain at an early stage.

The magnet can preferably be a permanent magnet. A particularly simple construction of the chain lifting device is enabled as a result. The magnet can also be an electromagnet. The electromagnet is supplied with electric power by way of the motor control unit. As a result, the electromagnet can be activated or deactivated in a simple manner, respectively. This enables the operator to switch the chain lifting device from the operating position to the off position in a simple manner.

In an embodiment, a shift unit for adjusting the magnet to the operating position and to the off position is provided. The shift unit can particular be a set of bellows or preferably a positioning electromagnet. By way of the shift unit, the position of the magnet can be varied in such a manner that the latter does not cause any deflection of the saw chain. If the chain lifting device has to be switched to the operating position, the magnet by way of the shift unit is repositioned in such a manner that the magnet causes a deflection of the saw chain on the slack side.

A method according to the disclosure for operating a chain saw provides that a chain lifting device of the chain saw deflects the saw chain in the direction away from a longitudinal axis of the guide bar. In the event of contact between the saw chain and a protective contact of the chain saw, the drive motor is preferably switched off by way of a motor control unit of the chain saw. As a result, the chain lifting device is protected and uncontrolled jumping of the saw chain and thus potential damage to the latter is avoided.

### BRIEF DESCRIPTION OF THE DRAWINGS

The invention will now be described with reference to the drawings wherein:

FIG. 1 shows an exploded illustration of a chain saw having a schematically illustrated chain lifting device;

FIG. 2 shows a schematic lateral illustration of the chain lifting device having a chain drive sprocket and a guide bar, having a saw chain tensioned by the chain lifting device;

FIG. 3 shows a schematic lateral illustration of the chain lifting device having a protective contact and a resilient protective plate;

FIG. 4 shows a schematic lateral illustration of the chain lifting device having a position sensor and a warning indicator;

FIG. 5 shows a schematic lateral illustration of the chain lifting device having a protective contact and a position sensor;

FIG. 6 shows a schematic lateral illustration of the chain lifting device having an electromagnet and a position sensor;

FIG. 7 shows a schematic lateral illustration of the chain lifting device having a shift unit by way of a set of bellows in the off position;

FIG. 8 shows a schematic lateral illustration of the chain lifting device having a shift unit by way of a set of bellows in the operating position;

FIG. 9 shows a schematic lateral illustration of the chain lifting device having a shift unit as an electromagnet in the off position; and,

FIG. 10 shows a schematic lateral illustration of the chain lifting device having a shift unit as an electromagnet in the operating position.

### DESCRIPTION OF THE PREFERRED EMBODIMENTS

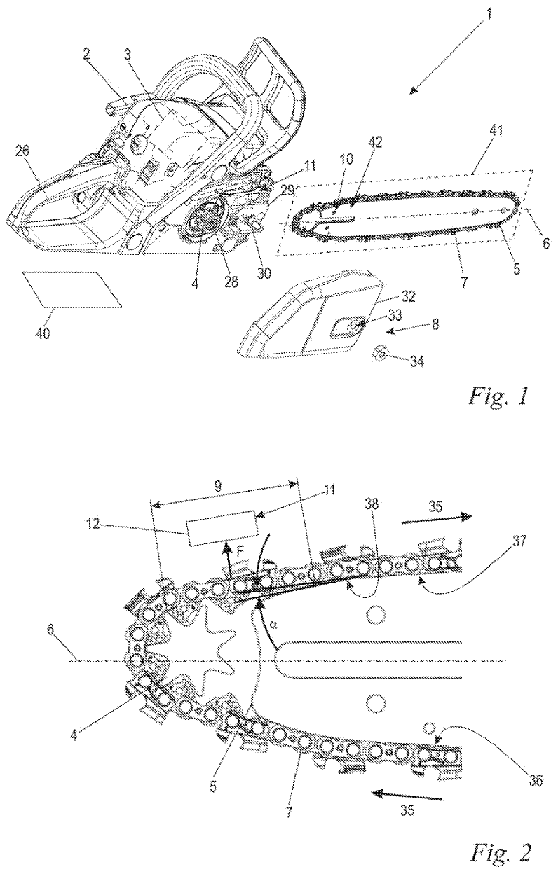

The chain saw 1 shown in FIG. 1 possesses a housing 2 on which a rear handle 26 as well as a bale handle 27 for guiding the chain saw 1 are established. A guide bar 5 protrudes toward the front on that side of the housing 2 that lies opposite the rear handle 26. A saw chain 7 is disposed in an encircling manner on the guide bar 5, the saw chain 7 being driven by a schematically illustrated drive motor 3. The drive motor 3 is in particular an internal combustion engine, advantageously a two-stroke engine or a four-stroke engine lubricated by a mixture. The drive motor 3 can also be an electric motor which can be supplied with power by way of a rechargeable battery or by way of a connecting cable.

The drive motor 3 drives the drive shaft 28 which protrudes from the housing 2. A chain drive sprocket 4 is disposed on the drive shaft 28. The chain drive sprocket 4 serves for driving the saw chain 7 which during operation is guided by way of the chain drive sprocket 4. A contact surface 29 on which the guide bar 5 bears in the assembled state of the chain saw 1 is configured on the housing 2. A stud bolt 30 is screwed into the housing 2. The stud bolt 30 in the embodiment possesses two threaded portions which are separated from one another by an encircling bead. The portion that faces the housing 2 is screwed into the housing 2. The guide bar 5 is fixed on the portion that protrudes outward. For fixing to the stud bolt 30, the guide bar 5 possesses a receptacle opening 31 which in the embodiment is configured as an elongate hole. A housing cover 32 which possesses an opening 33 for the stud bolt 30 is provided for fixing the guide bar 5. The housing cover 32 is to be fixed on the stud bolt 30 by way of a nut 34. The housing cover 32 has a clamping face that faces the guide bar 5 and conjointly with the nut 34 forms a fastening arrangement 8. In the fixed position of the fastening arrangement 8, the guide bar 5 at the end 42 thereof is held between the contact surface 29 of the housing 2 and the clamping face of the housing cover 32 so as to be clamped by way of the nut 34. In the released position of the fastening arrangement 8, the nut 34 is released, and the guide bar 5 by way of a tensioning device 10 is displaceable in the longitudinal direction of the guide bar 5 toward the front, away from the chain drive sprocket 4.

As is shown in FIG. 1, the guide bar 5 possesses a longitudinal axis 6. In a state of the chain saw 1 in which the latter is placed on a flat horizontal base 40, the longitudinal axis 6 runs centrally through the guide bar 5 so as to be approximately parallel to the horizontal base 40. The term “approximately” is to be understood in such a manner that the longitudinal axis 6 and the base 40 enclose an angle of at most 15°. The guide bar 5 possesses a longitudinal plane 41 which, in a state of the chain saw 1 in which the latter is placed on a flat horizontal base 40, contains the longitudinal axis 6 and is perpendicular to the base 40.

The tensioning device 10 serves for tensioning the saw chain 7. The tensioning device 10 in FIG. 1 is only indicated by openings in the guide bar 5 which form only part of the tensioning device 10. Further component parts of the tensioning device 10 that are not illustrated engage in these openings, as a result of which the tensioning device 10 in the direction of the longitudinal axis 6 is fixedly connected to the guide bar. While the fastening arrangement 8 is released, the operator, by way of the tensioning device 10, can displace the guide bar 5 in the direction of the longitudinal axis 6 and as a result tension the saw chain 7. To this end, different tensioning devices 10 which are known in the most varied embodiments from the prior art can be used.

As is shown in FIG. 1, the chain saw 1 also includes a chain lifting device 11 which serves for deflecting the saw chain 7 in the direction away from the longitudinal axis 6. The chain lifting device 11 is preferably disposed on the housing 2 of the chain saw 1, in particular in the longitudinal direction 6 of the guide bar 5 between the chain drive sprocket 4 and the guide bar 5.

As is shown in FIG. 2, the chain drive sprocket 4 drives the saw chain 7 so as to revolve in a movement direction 35 about the guide bar 5. The movement direction 35 of the saw chain 7, corresponding to a state of the chain saw 1 in which the latter is placed on the base 40, on a top side 37 of the guide bar 5 that faces away from the base 40 runs from the chain drive sprocket 4 in the direction of the guide bar 5, and on a bottom side 36 of the guide bar 5 that faces the base 40 runs from the guide bar 5 in the direction toward the chain drive sprocket 4.

A lead side is configured between the guide bar 5 and the chain drive sprocket 4 on the bottom side 36 as well as on the top side 37 of the guide bar 5. The lead side configured between the chain drive sprocket 4 and the top side 37 of the guide bar 5 is a slack side 9. At the end of the slack side 9 the saw chain 7 again contacts the guide bar 5 in a contact zone 38. The slack side 9 is a loose, sagging lead side which is not pulled by the chain drive sprocket 4. The lead side configured between the bottom side 36 of the guide bar 5 and the chain drive sprocket 4 is a taut side.

The chain lifting device 11 only schematically illustrated in FIG. 2 acts on the saw chain 7 in such a manner that the saw chain 7 in the slack side 9 is deflected in the direction away from the longitudinal axis 6 of the guide bar 5. As a result of the deflection of the saw chain 7, the sagging of the saw chain 7 in the slack side 9 is reduced, in particular completely eliminated, as a result of which the contact angle α is reduced. Sagging in the slack side prevails when the chain lifting device 11 is situated in an off position 21 and the chain lifting device 11 does not cause any deflection of the saw chain 7 in the slack side 9. The contact angle α is enclosed by the top side 37, in particular by the contour of the guide bar 5 on the top side 37, and the movement direction 35 of the saw chain 7 in the contact zone 38. The smaller the contact angle u, the smaller the contact forces in the contact zone 38 between the saw chain 7 and the guide bar 5 as well. The contact angle α is preferably less than 15°, in particular less than 10°, advantageously less than 5°. The chain lifting device 11 is conceived in such a manner that an ideally tangential contact between the saw chain 7 and the guide bar 5 is enabled. When the saw chain 7 is deflected by the chain lifting device 11, the contact zone 38 between the saw chain 7 and the guide bar 5 is displaced in the direction of the longitudinal axis 6 away from the chain drive sprocket 4. The contact angle α between the guide bar 5 and the saw chain 7 is thus reduced. As a result, the noise level is minimized when the saw chain 7 impacts the guide bar 5. Since the contact forces are reduced in the contact zone 38, this also has the effect of an operation of the chain saw 1 which is gentle on the material, as a result of which the service life of the saw chain 7 and of the guide bar 5 is increased.

As is shown in FIG. 2, the chain lifting device 11 is configured as a magnet 12, 14. The magnet 12, 14 generates a magnetic force F which deflects the saw chain 7 away from the longitudinal axis 6 of the guide bar 5. As a result, a non-contacting interaction between the chain lifting device 11 and the saw chain 7 is possible. The chain lifting device 11 thus acts in a wear-free manner on the saw chain 7. In an alternative embodiment of the chain saw, the chain lifting device 11 could also be configured as a mechanical deflection element in the form of guide bars, deflection rollers, linear bearings, et cetera.

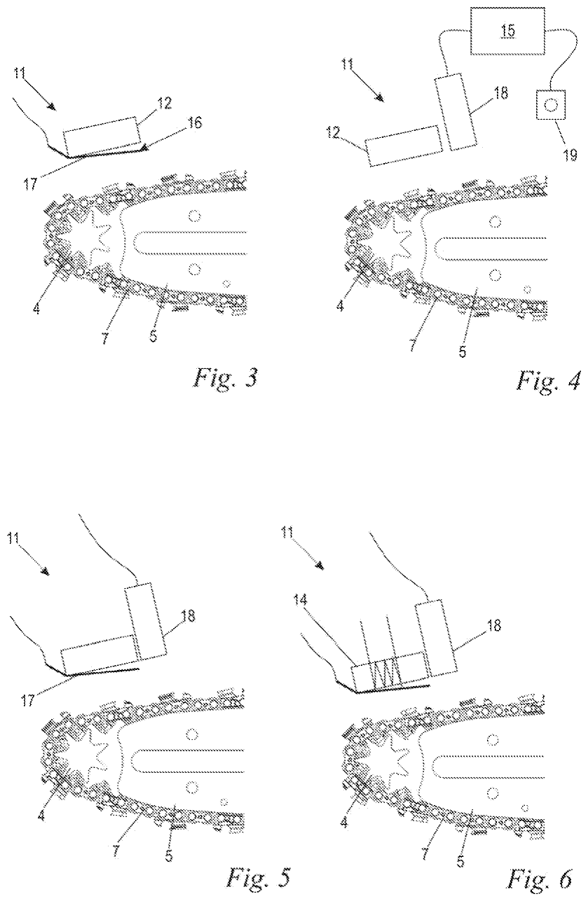

As is shown in FIG. 3, a protective contact 16 can be provided in an advantageous embodiment of the chain lifting device 11. The protective contact 16 can preferably be configured as a protective plate 17. In an advantageous embodiment of the chain saw 1, the protective contact 16 is disposed between the magnet 12, 14 and the saw chain 7. Once the sagging of the saw chain 7 in the slack side 9 of the saw chain 7 reaches a corresponding size, contact is established between the deflected saw chain 7 and the protective contact 16. In order to avoid potential damage to the chain lifting device 11, it is provided in the embodiment as per FIG. 3 that the chain saw 1 is switched off. The protective plate 17 forms an additional mechanical protection for the chain lifting device 11. The protective plate 17 can preferably be configured so as to be resilient, as a result of which the protective plate 17 can elastically yield when contacting the saw chain 7. Damage to the saw chain 7 and to the protective plate 17 can be avoided as a result. In an advantageous embodiment, the signal of the protective contact 16 can be further processed by way of a motor control unit 15. The contact between the saw chain 7 and the protective contact 16 can be signaled to the operator by way of a warning indicator 19, for example. The operator can then stop the operation of the chain saw 1 and readjust the tension of the saw chain 7 by way of the tensioning device 10.

In an embodiment of the chain saw as per FIG. 4, the chain lifting device 11 includes a position sensor 18 which determines the spacing between the magnet 12, 14 and the saw chain 7. The position sensor 18 can preferably be disposed next to the magnet 12, 14. The position sensor 18 is coupled to the warning indicator 19 by way of a motor control unit 15. In the case of pre-set threshold values, the operator can be informed about decreasing spacings by way of different types of signals. The warning indicator 19 can be formed from one or a plurality of lights which signal the spacing between the saw chain 7 and the magnet 12, 14 by way of the flashing frequency or the color, for example.

As is shown in FIG. 5, the embodiments of FIGS. 3 and 4 can be combined with one another in such a manner that, apart from the position sensor 18, a protective contact 16 for switching off the chain saw 1 and for protecting the chain lifting device 11 can also be provided.

A further embodiment of the chain lifting device 11, in which an electromagnet 14 instead of a permanent magnet 12 is provided for deflecting the saw chain 7, is shown in FIG. 6. The electromagnet 14 is supplied with electric power by way of the motor control unit 15. The electromagnet 14 can thus be switched on and off in a targeted manner by way of the motor control unit 15. This is advantageous in particular when the tension of the saw chain 7 has to be readjusted. When the chain saw is out of operation, the electromagnet 14 and thus the chain lifting device 11 are also deactivated. This enables the operator to simply push the guide bar 5 toward the front and to tension the saw chain 7 while the chain lifting device 11 is deactivated. Furthermore, the embodiment of the electromagnet can also be combined with the protective plate and the position sensor 18 having the warning indicator 19.

If the chain lifting device 11 is provided with a permanent magnet 12, the latter has to be disassembled when readjusting the tension of the saw chain 7. Once the saw chain is tensioned, the permanent magnet 12 can be reinserted into the housing 2. Alternatively, the operator has to apply a tensioning force which is so high that the saw chain is tensioned counter to the magnetic force F of the permanent magnet 12.

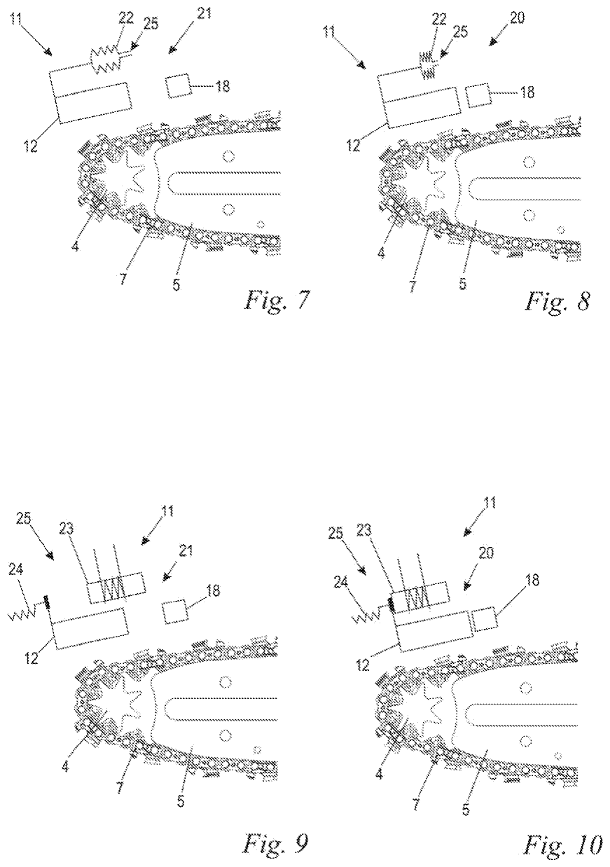

A chain lifting device 11 having permanent magnets 12 is shown in FIGS. 7 and 8. The chain lifting device 11 furthermore includes a shift unit 25 by way of which the permanent magnet 12 can be moved to an off position 21 (FIG. 7) and an operating position 20 (FIG. 8). The shift unit 25 is conceived in such a manner that the chain lifting device 11 in the case of a switched-off chain saw 1 is situated in the off position 21. Accordingly, the permanent magnet 12 is pushed away from the saw chain 7 by the shift unit 25 in such a manner that the permanent magnet 12 does not cause any deflection of the saw chain 7 in the slack side 9. When the chain saw 1 is switched on, the chain lifting device 11 is switched to the operating position 20 by way of the shift unit 25. The permanent magnet 12 in this instance, by way of the shift unit 25, is positioned close to the saw chain 7 in such a manner that the latter is deflected again by way of the magnetic force F.

The shift unit 25 in the embodiment as per FIGS. 7 and 8 is configured as a set of bellows 22. The permanent magnet 12 is fastened to the set of bellows 22. The set of bellows 22 can be coupled to the motor by way of a Venturi principle, for example. The permanent magnet 12 is correspondingly displaced by contracting and expanding the set of bellows 22. Of course, this embodiment of the chain saw 1 can also be combined with the position sensor 18 for determining the spacing between the saw chain 7 and the permanent magnet 12.

In the embodiment as per FIGS. 9 and 10 the shift unit 25 is configured by a positioning electromagnet 23 having a return spring 24. The permanent magnet 12 is connected to an anchor plate which is fastened to the return spring 24. The positioning electromagnet 23 when activated attracts the anchor plate and thus also the permanent magnet 12 toward the electromagnet 23, as a result of which the chain lifting device is activated. When the positioning electromagnet 23 is deactivated, the return spring 24 pulls the permanent magnet 12 back to the initial position and thus deactivates the chain lifting device 11. The positioning electromagnet 23 is coupled to the motor control unit 15 and is supplied with electric power by way of the latter. The positioning electromagnet 23 can thus be actuated in a targeted manner by way of the motor control unit 15, and the chain lifting device 11 can be switched to the operating position 20 and to the off position 21. The embodiments of FIGS. 7 to 10 can also be combined with the warning indicator.

It is understood that the foregoing description is that of the preferred embodiments of the invention and that various changes and modifications may be made thereto without departing from the spirit and scope of the invention as defined in the appended claims.

What is claimed is:

1. A chain saw comprising:
a housing;
a chain drive sprocket;
a guide bar defining a longitudinal axis;
a saw chain guided on said guide bar;
a drive motor configured to drive said saw chain guided on said guide bar via said chain drive sprocket;
a releasable fastening arrangement;
a tensioning device;
said guide bar being held on said housing via said releasable fastening arrangement;
said guide bar being displaceable via said tensioning device in a direction of the longitudinal axis of said guide bar in relation to said housing when said fastening arrangement is released;
said saw chain having a slack side between said chain drive sprocket and said guide bar;
a chain lifting device configured separately from said tensioning device;
said chain lifting device being configured to deflect said saw chain in a direction away from the longitudinal axis of said guide bar; and,
said chain lifting device including a magnet, wherein said saw chain is deflectable via a magnetic force exerted by said magnet at said slack side.

2. The chain saw of claim 1, wherein said chain lifting device for deflecting said saw chain is formed in said slack side.

3. The chain saw of claim 1, wherein said chain lifting device is configured to deflect said saw chain during operation of said chain saw.

4. The chain saw of claim 1, wherein said chain lifting device is disposed on said housing so as to be adjacent to said slack side.

5. The chain saw of claim 1, wherein said chain lifting device has an operating position and an off position; and, said chain lifting device is configured to cause a deflection of said saw chain only in said operating position.

6. The chain saw of claim 1 further comprising:
a motor control unit;
said chain saw having a protective contact for the avoidance of contact between said chain lifting device and said saw chain; and,
said protective contact being connected to said motor control unit.

7. The chain saw of claim 6, wherein said protective contact interacts with a protective plate.

8. The chain saw of claim 7, wherein said protective plate is configured to be resilient.

9. The chain saw of claim 6, wherein said chain lifting device includes a position sensor for detecting a spacing between said magnet and said saw chain.

10. The chain saw of claim 9, wherein said spacing between said magnet and said saw chain determined by said position sensor is signaled via a warning indicator.

11. The chain saw of claim 1, wherein said magnet is a permanent magnet.

12. The chain saw of claim 1, wherein said magnet is an electromagnet.

13. The chain saw of claim 1 further comprising a shift unit for adjusting said magnet into the operating position and into the off position.

14. The chain saw of claim 13, wherein said shift unit is a set of bellows or a positioning electromagnet.

15. A method for operating a chain saw, the chain saw including a housing, a chain drive sprocket, a guide bar defining a longitudinal axis, a saw chain guided about the guide bar, and a drive motor configured to drive the saw chain via the chain drive sprocket, the chain saw further including a chain lifting device having a magnet, the saw chain having a slack side, the method comprising:
deflecting the saw chain on the slack side in a direction away from the longitudinal axis of the guide bar via a magnetic force exerted by the magnet.

16. The method of claim 15 further comprising switching off the chain saw via a motor control unit upon contact between the saw chain and a protective contact of the saw chain.
